(19) United States
(12) Patent Application Publication
(10) Pub. No.: US 2015/0264487 A1
(43) Pub. Date: Sep. 17, 2015

(54) Full circumferential geometry voice coil bobbin made with non-metal or metal

(71) Applicant: Edward Ku, Tuen Mun (HK)

(72) Inventors: Edward KU, Tuen Mun (HK); Richard Louis WEISMAN, Pasadena, CA (US)

(73) Assignee: Edward Ku, Tuen Mun (HK)

(21) Appl. No.: 14/207,645

(22) Filed: Mar. 13, 2014

(51) Int. Cl. H04R 9/02; H04R 1/00

(52) U.S. Cl. CPC H04R 9/025; H04R 1/00

(57) ABSTRACT

An electromagnetic loudspeaker transducer; where its voice coil bobbin has a fully circumferential geometry to provide increased mechanical strength. When the bobbin to be made with sheet metal and sheet metal deep drawn it further provides a stiffened construction by work hardened metal during the process. The full circumferential bobbin made with metal also serve as a one turn coil to short out the induced current from back electromotive force due to the voice coil moving under the magnetic field from the audio transducer's motor structure. The bobbin also allows a support feature for the transducer diaphragm to attach to and avoid leaving a dent mark on sheet metal diaphragms.

### BACKGROUND OF THE INVENTION

This invention relates to electromagnetic loudspeaker transducer, more specifically to voice coil bobbin and yet more specifically to a loudspeaker transducer having a full circumferential geometry voice coil bobbin allowing a high rigidity, a very concentric voice coil bobbin made of non-metal or metal. The full circumferential geometry metal bobbin also reduce harmonic distortion generated from induced current to voice coil from back electromotive force by acting as a single turn coil and the voice coil assembly acting as the transformer with a single turn coil to many turns in the voice coil, most of the induced current from the back electromotive force is then converted into heat and therefore reduce the back induced current in the voice coil and therefore reduce harmonic distortion. The full circumferential geometry metal bobbin improves transient respond of the audio transducer with increased Eddy current developed in the bobbin and dampening the pistol movement of the moving structure of an audio transducer. The kinetic energy is then transferred to heat.

Audio electromagnetic transducers are known to use a voice coil with a variety of bobbin design with a roll of sheet material that is made of paper, polymer, composite or metal and wounded with a piece of Kraft paper tape to from a circular shape for the voice coil to attach to it. The bobbin provides mechanical strength for the copper coil to maintain a circular shape and also serve as a mechanical medium for the voice coil to mate with the diaphragm, transmitting the force from the voice coil to the diaphragm of the transducer.

However, common bobbin design with rolling a sheet have drawbacks with imperfect concentricity and limited mechanical strength and yet it do not allow extra support and mating features for diaphragm attachment and yet a metal bobbin cannot reduce harmonic distortion by shorting out the induced current from back electromotive force as it do not form a ring. In a common audio transducer, an extra aluminum or copper shorting rings in motor structure is needed to provide such a function. And surface for generating eddy current is slightly lower.

The inventors' U.S. Pat. No. 8,059,857, increase the rigidity of the voice coil bobbin by adding an extra layer of high strength material. And the invention in US Patent application no. US20020141609, US20040062415 employ different approach by using high mechanical strength material as bobbin material which requires extra or complicated costly process to achieve. Yet do not provide the benefits of harmonic distortion reduction as a shorting ring for transforming the induced current from back induced electromotive force if the bobbin is made of metal.

### BRIEF SUMMARY OF THE INVENTION

To attain this, the present invention comprises a full circumferential monolithic bobbin, a voice coil coupled to the bobbin made of metal or non-metal, and Kraft paper wound to provide attachment interface for voice coil to the bobbin.

In one embodiment, the voice coil assembly has two lead wires is coming out from the voice coil and the voice coil attached to the interfacing Kraft paper wound on top of the bobbin.

In yet another embodiment the bobbin made with a supporting interface for the diaphragm which has matching shape and curvature of the diaphragm where the supporting interface could prevent denting or leaving a mark on the diaphragm. The flange can also facilitate heat conduction to the diaphragm.

### BRIEF DESCRIPTION OF THE DRAWINGS

FIG. 1 shows an audio transducer voice coin and bobbin assembly according to one embodiment of this invention.

FIG. 2 shows another voice coil and bobbin assembly that may be used in practicing this invention.

### DETAILED DESCRIPTION OF THE INVENTION

The invention will be understood more fully from the detailed description given below and from the accompanying drawings of embodiments of the invention which, however, should not be taken to limit the invention to the specific embodiments described, but are for explanation and understanding only.

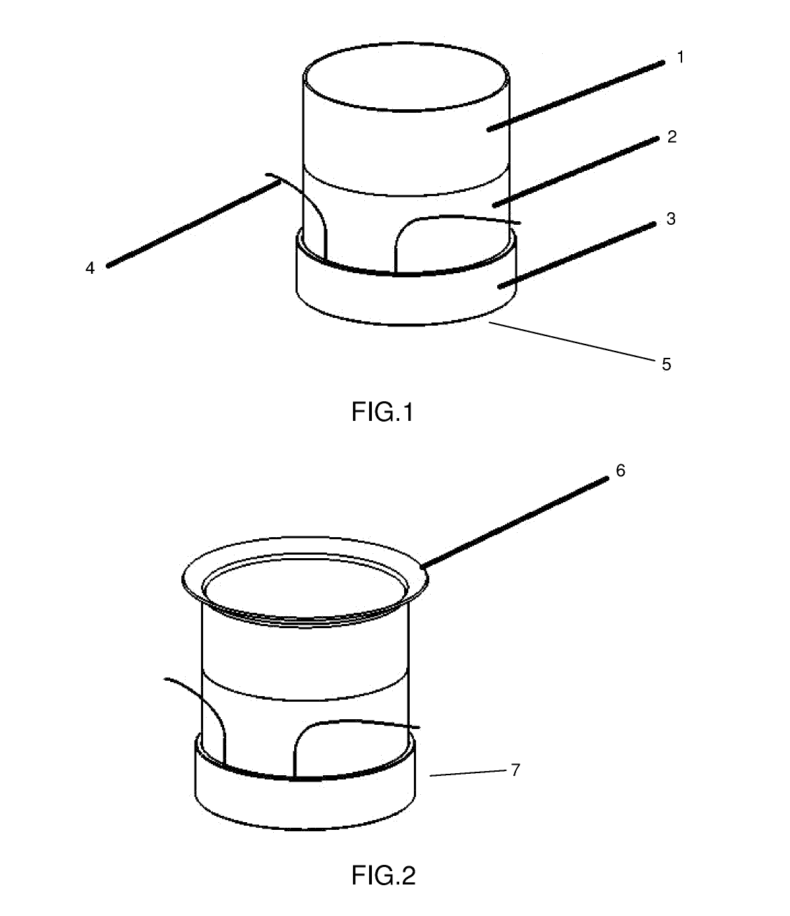

FIG. 1 illustrates a loudspeaker voice coil assembly 5 according to one embodiment of this invention, in perspective view. The voice coils includes a full circumference metal bobbin 1 coupled to the coil 2 by a layer of interface material 3 and lead wires 4 extended from the voice coil.

The voice coil bobbin 1 from the voice coil assembly 5. The voice bobbin has a very high rigidity, because the bobbin is a continuous, monolithic, full circumference ring. And when the bobbin is made with sheet metal, work hardened during the deep drawn process, provides even higher mechanical strength. The one piece full circumference cylindrical voice coil bobbin when made of metal, permits the use of it as a back electromotive force (EMF) induced current shorting ring, act as a transformer with the voice coil itself, could reduce harmonic distortion of the audio transducer generated from induced back EMF. It also dampens the transducer movement with eddy currents when specific metal allows eddy current developed within.

In a conventional voice coil bobbin, such a rigidity and shorting ring properties could not achieved, because it was made by rolling a sheet which must have an open slit which do not form a continuous, monolithic, full circumference ring.

FIG. 2 illustrates another voice coil assembly 7 which may be used in practicing this invention. The flanged bobbin 6 enables the anchoring of a diaphragm assembly at the flange of the voice coil bobbin and conducts heat to the diaphragm.

In a conventional voice coil bobbin, such an anchoring interface will need an extra bobbin part to be created.

What is claimed is:

1. An audio transducer voice coil assembly comprising a monolithic cylindrical bobbin made of non-metal or metal with full circumferential geometry providing high mechanical strength.

2. An audio transducer voice coil assembly comprising a monolithic cylindrical metal bobbin with full circumferential geometry to allow it to act as a one turn coil and shorting ring to the turns in the voice coil, acting as a transformer. Therefore reducing harmonic distortion result from induced current due to back electromotive force when the voice coil assembly moments driver by electric current under the motor structure's magnetic field.

3. An audio transducer voice coil assembly comprising a monolithic cylindrical bobbin made of non-metal or metal with a flange to provide anchor and heat conduction to the diaphragm.
